(19) United States
(12) Patent Application Publication
(10) Pub. No.: US 2023/0311827 A1
(43) Pub. Date: Oct. 5, 2023

(54) NORMALLY CLOSED HYDRAULIC VALVE AND BRAKE SYSTEM USING SAME

(71) Applicant: ZF Active Safety US Inc., Livonia, MI (US)

(72) Inventor: Blaise J. Ganzel, Ann Arbor, MI (US)

(21) Appl. No.: 17/708,108

(22) Filed: Mar. 30, 2022

(51) Int. Cl. B60T 8/94; B60T 13/68; F16K 31/06

(52) U.S. Cl. CPC B60T 8/94; B60T 13/686; F16K 31/0624; B60T 2270/402

(57) ABSTRACT

A dual-directional normally closed valve (“NC valve”) includes a housing having NC valve first and second passages in fluid communication with a center bore. An armature is provided for selective longitudinally reciprocating motion with respect to the center bore between first and second armature positions. A valve seat is located within the center bore in selective fluid communication with the NC valve first and second passages. A poppet is located at least partially within the housing and is interposed longitudinally between the armature and the valve seat. The poppet is at least partially maintained in engagement with the armature and carried thereby for selective longitudinally reciprocating motion with respect to the valve seat between first and second poppet positions. The poppet defines a dual-directional valving structure cooperatively with the valve seat.

### TECHNICAL FIELD

This disclosure relates to an apparatus and method for use of a normally closed hydraulic valve and, more particularly, to a method and apparatus of a hydraulic brake system for actuating at least one wheel brake using a normally closed hydraulic valve.

### BACKGROUND

A brake system may include anti-lock control including a pedal-operated hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Solenoid-operated binary open/closed type valves (a.k.a., two-position two-way valves) of many different designs are used to provide fluid control and routing functions to hydraulic brake systems in a variety of use environments. For the sake of clarity, the below description presumes that the open/closed valves under discussion are simple one-input, one-output valves. Generally, such open/closed type valves are either open or closed in a default, nonpowered “resting” mode, and are then powered via solenoid, in a known manner, to the other of the open or closed status as desired. When electrical power to the solenoid is removed (intentionally or not), the open/closed type valve “fails” to the default mode. One of ordinary skill in the art can take advantage of the default modes of the open/closed type valves to provide a hydraulic brake system with desired “nonpowered” responses, which will perform predictably in the event of power failure.

In many of those use environments, it is important for the open/closed type valve to resist hydraulically failing (being overpowered and forced into the other open/closed status) by relatively high hydraulic pressure going through the valve body in a first direction (e.g., from upstream to downstream). For example, in some systems, the first-direction pressure might be in the range of about two hundred bar. Conversely, the hydraulic pressure exerted upon certain open/closed type valves in a second, opposite direction (e.g., from downstream to upstream) might be significantly less than the first-direction pressure. For example, in some systems, the second-direction pressure might be in the range of about twenty bar. As such, the designer of these known open/closed type valves is able to configure the mechanical workings (e.g., internal springs, seats, bushings) of the valve to “hold off” relatively high hydraulic pressure in only one direction. There are certain hydraulic brake systems, however, with relatively high hydraulic pressures needing to be exerted against the open/closed type valves in both of the first and second directions.

### SUMMARY

In an aspect, a dual-directional normally closed valve (“NC valve”) is disclosed. A housing has a center bore extending longitudinally from a first housing surface. The housing includes an NC valve first passage in fluid communication with the center bore. The housing includes an NC valve second passage extending therethrough in fluid communication with the center bore. The NC valve first passage is located longitudinally between the first housing surface and the NC valve second passage. An armature is provided for selective longitudinally reciprocating motion with respect to the center bore between first and second armature positions. A valve seat is located within the center bore in selective fluid communication with the NC valve first and second passages. A poppet is located at least partially within the housing and is interposed longitudinally between the armature and the valve seat. The poppet is at least partially maintained in engagement with the armature and carried thereby for selective longitudinally reciprocating motion with respect to the valve seat between first and second poppet positions. The poppet defines a dual-directional valving structure cooperatively with the valve seat. The NC valve first passage, poppet, valve seat, and NC valve second passage cooperatively define a dual directional flow fluid path therebetween, the dual directional flow fluid path selectively permitting fluid communication therethrough between the NC valve first and second passages. The dual directional flow fluid path permits fluid communication therethrough when the armature is in the second armature position and the poppet is in the second poppet position. The dual directional flow fluid path restricts fluid communication therethrough when the armature is in the first armature position and the poppet is in the first poppet position.

### BRIEF DESCRIPTION OF THE DRAWINGS

For a better understanding, reference may be made to the accompanying drawings, in which:

FIG. 1 is a schematic partial side view of a dual-directional normally closed valve (“NC valve”) according to an aspect of the present invention, in a first configuration;

FIG. 2 is a schematic partial side view of the NC valve of FIG. 1, in a second configuration;

FIG. 3 is a schematic hydraulic diagram of a first example brake system including the NC valve of FIG. 1; and

FIG. 4 is a schematic hydraulic diagram of a second example brake system including the NC valve of FIG. 1.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

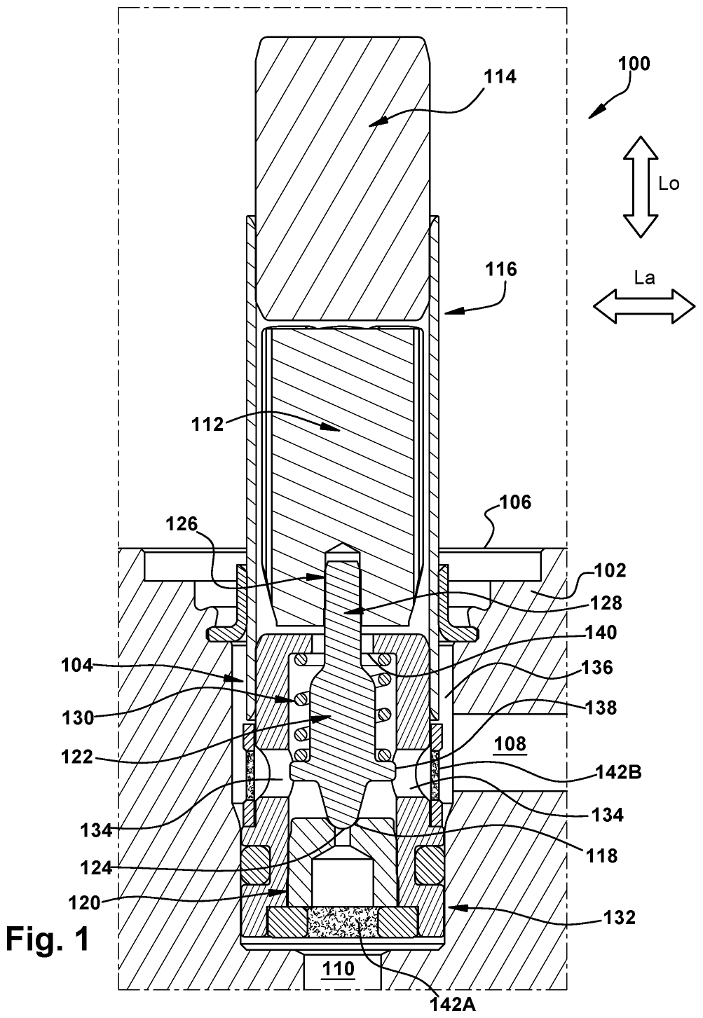

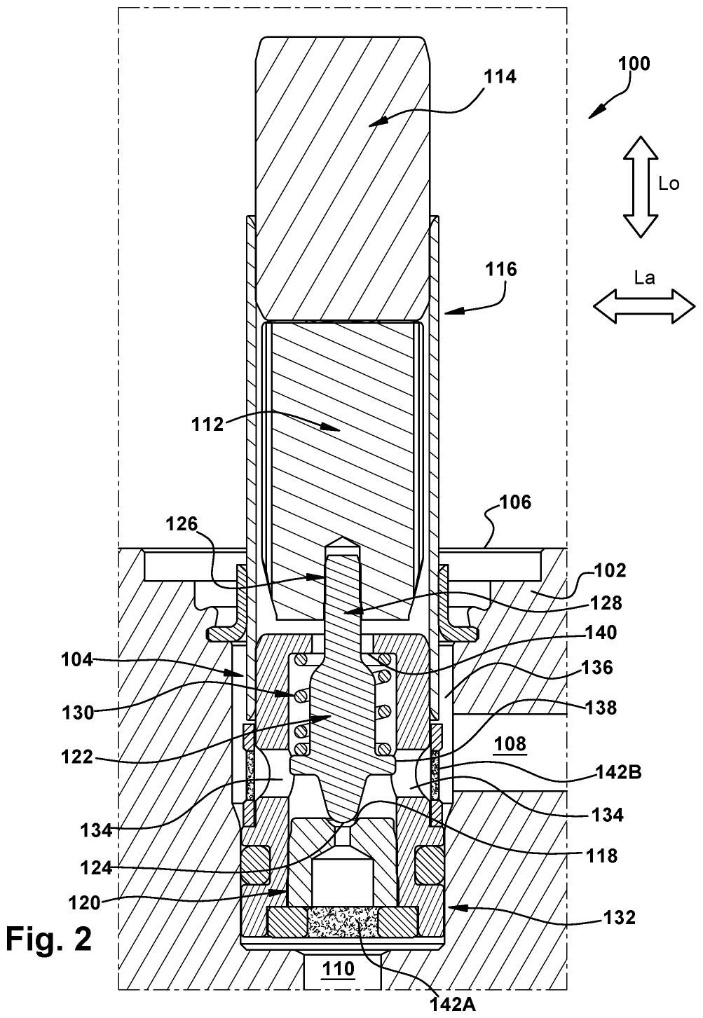

FIGS. 1-2 schematically depict a dual-directional normally closed valve (“NC valve”) 100, including a housing 102 having a center bore 104 extending longitudinally from a first housing surface 106. The housing 102 includes an NC valve first passage 108 in fluid communication with the center bore 104. The housing 102 includes an NC valve second passage 110 extending therethrough in fluid communication with the center bore 104. The NC valve first passage 108 is located longitudinally between the first housing surface 108 and the NC valve second passage 110. The term “longitudinal” is used herein to indicate a direction along a longest dimension of the NC valve, and is substantially in the vertical direction, as indicated by arrow “Lo”, in FIGS. 1-2. The NC valve second passage 110 may be located at a portion of the center bore 104 longitudinally furthest from the first housing surface 106, for some use environments of the NC valve 100.

Although the NC valve 100 is shown in cross-section in FIGS. 1-2, one of ordinary skill in the art will readily be able to envision the manner in which the component parts of the NC valve 100 interact three-dimensionally (e.g., in sealing and/or fluid communicating manners) with each other, given the teachings of the present invention. Any suitable number, configuration, and style of additional structures may be provided to the valve 100 to facilitate assembly and/or use thereof, such as, but not limited to, the stepped center bore 104 shown in FIGS. 1-2.

An armature 112 is located at least partially within the housing 102 for selective longitudinally reciprocating motion with respect to the center bore 104. The armature 112 moves between first and second armature positions in any desired manner, such as the electrically and/or magnetically controlled and exerted forces described below with reference to FIGS. 1-2. The armature 112 is depicted in a first, “resting”, armature position in FIG. 1 and in a second, “powered” or “actuated”, armature position in FIG. 2. Because the NC valve 100 is a “normally closed” valve, fluid flow between the NC valve first and second passages 108 and 110 is substantially prevented with the armature 112 in the first position and is substantially permitted with the armature 112 in the second position, as will be discussed below.

The NC valve 100 includes a core 114 for selectively magnetically attracting the armature 112. The core 114 is located longitudinally directly adjacent a core-activated surface (an uppermost surface, as shown in FIG. 1) of the armature 112. The core 114 is selectively electrically energized to magnetically drive the armature 112 between the first and second armature positions of FIGS. 1-2, respectively.

An armature-attracting face (a lowermost surface, as shown in FIG. 1) of the core 114 and the core-activated surface of the armature 112 may both be substantially planar. This is in contrast to the stepped armature-attracting face of known prior art two-stage simulator valves, and may be helpful in attracting the armature 112 upward toward the core 114 with more efficient and forceful motion than in those known valves. Additionally, as shown in FIGS. 1-2, the armature-attracting face of the core 114 and the core-activated surface of the armature 112 may be substantially uninterrupted by cavities or protrusions, such that the entire area of these faces is available for magnetic attraction to develop therebetween. At least partially as a result of these uninterrupted face profiles, the NC valve 100 is configured for very effective and relatively high-strength development of magnetic forces between the armature 112 and the core 114.

A core sleeve 116 may be received at least partially in the center bore 104 of the housing 102 to maintain the core 114 in spaced relationship with the housing 102. When the core sleeve 116 is present, the armature 114 may be at least partially enclosed within the core sleeve 116 and guided thereby for selective longitudinal reciprocating motion with respect to the core 114. It is contemplated that the core sleeve 116 may entirely longitudinally enclose the armature 114 therein, with the core 114 located at a first end of the core sleeve 116 and at least partially enclosed therein. The core sleeve 116 may be maintained in the center bore 104 of the housing 102 in any desired manner such as, but not limited to, the a staked connection shown in the Figures.

A valve seat 118 is located within the center bore 104 in selective fluid communication with the NC valve first and second passages 108 and 110. As shown in FIGS. 1-2, the NC valve 100 may include a seat ring 120 located within the center bore 104 adjacent the NC valve second passage 110. When present, the seat ring 120 defines the seat 118.

A poppet 122 is located at least partially within the housing 102 and is interposed longitudinally between the armature 112 and the valve seat 118. The poppet 122 is at least partially maintained in engagement with the armature 112 and is carried thereby for selective longitudinally reciprocating motion with respect to the valve seat 118 between first and second poppet positions. When the poppet 122 is in the first poppet position, as shown in FIG. 1, a poppet tip 124 is located in sealing engagement with the valve seat 118 to prevent fluid flow between the NC valve first and second passages 108 and 110. Thus, the poppet 122 defines a dual-directional valving structure cooperatively with the valve seat 118.

In contrast, when the poppet 122 is in the second poppet position, as shown in FIG. 2, the armature 116 has been magnetically attracted toward the core 114. The armature 112 is longitudinally interposed between the core 114 and the poppet, and the armature 112 carries the poppet 122 for reciprocal motion with respect to the valve seat 118. When the armature 112 has “lifted” the poppet 122 away from the valve seat 118, into the second poppet position shown in FIG. 2, fluid flow between the NC valve first and second passages 108 and 110 is permitted, for as long as the NC valve 100 remains in this “energized” status.

In order to carry the poppet 122 as described, the armature 112 may include a poppet-receiving aperture 126 extending into an armature 112 surface which is longitudinally opposite the core-activated surface. When present, the poppet-receiving aperture 126 may maintain at least a stem portion 128 of the poppet therein, to provide longitudinally reciprocal motive power to the poppet 122.

The NC valve 100 may include an annular valve body 132 located in the center bore 104 and substantially laterally surrounding at least a portion of the poppet 122. The “lateral” direction is substantially perpendicular to the longitudinal direction, and is horizontal in the orientation of FIGS. 1-2, as shown by lateral arrow “La”. When present, the valve body 132 may include at least one body side aperture 134 extending laterally therethrough. The or each body side aperture 134 may be longitudinally aligned with at least a portion of the NC valve first passage 108 and permitting fluid flow through the body side aperture 134 from the NC valve first passage 108 to or from the area of the valve seat 118. “Longitudinally aligned” is used here to indicate a situation in which at least portions of two different components are co-located at a single location along a longitudinal dimension of the NC valve 100. As shown in FIGS. 1-2, an annular space 136 may be formed within the center bore 104 around an outside surface of the valve body 132, to permit fluid to flow into and out of portions of the valve body 132 which are not directly adjacent the NC first valve passage 108.

The NC valve 100 may also include a poppet spring 130 biasing the poppet 122 into sealing engagement with the valve seat 118, when the poppet 122 is in the first poppet position. More specifically, the poppet spring 130 may be interposed longitudinally between a poppet shoulder 138 of the poppet 122 and another structure of the NC valve 100. The poppet spring 130 may extend longitudinally between, and exert compressive force upon, a poppet shoulder 138 of the poppet 122 and a body shoulder 140 of the valve body 132. It is contemplated that, when the NC valve 100 does not include a valve body 132 or includes a differently constructed valve body 132 from that shown, a separate retainer (not shown), inner surface of the center bore 104, or any other suitable structure could resist compressive force of the poppet spring 130. Regardless of configuration, the poppet spring 130—as configured and arranged with respect to other components of the NC valve 100 as shown in the Figures—may assist with urging the poppet 122 downward, the orientation of FIGS. 1-2, upon release of magnetic force between the core 114 and the armature 112.

It is also contemplated that at least one of the NC valve first and second passages 108 and 110 may include at least one filter 142 (two shown in FIGS. 1-2 by way of example) directly adjacent thereto within the center bore 104 for filtering fluid flow therethrough. When present, the filter(s) 142 may be of any desired type, and may be located in any desired position in the NC valve 100. For example, the depicted lower filter 142A is located below the poppet 122 in the center bore 104. It is contemplated that a cylindrical upper filter 142B could also or instead be located in an area substantially surrounding the poppet 122; that is, immediately between the NC valve first passage 108 and the valve body 132. One of ordinary skill in the art will be readily able to provide one or more suitable filters 142, as desired for a particular use environment of the present invention.

It should be noted that, configured as shown in FIGS. 1-2, the dual-directional valving structure cooperatively defined by the poppet 122 and the valve seat 118 may be configured to resist a larger amount of incoming fluid pressure from the NC valve second passage 110 than an amount of incoming fluid pressure from the NC valve first passage 108, with a lower solenoid force than that which would be needed for similar pressure holdoffs in existing valves. This property may be suitably utilized as desired by one of ordinary skill in the art when configuring a brake system including the NC valve 100.

As mentioned above, the poppet spring 130 may be interposed longitudinally between the valve body 132 and the poppet shoulder 138. The poppet spring 130 thus normally biases poppet 122, and thus the attached armature 112, longitudinally away from the core 114. Magnetic force from the core 114 must then overcome the spring force of the poppet spring 130 to move the armature 112 from the first armature position, shown in FIG. 1, to the second armature position, shown in FIG. 2.

In summary of the structures depicted in FIGS. 1-2 and described above, the NC valve first passage 108, poppet 122, valve seat 118, and NC valve second passage 110 cooperatively define a dual directional flow fluid path therebetween. The dual directional flow fluid path selectively permits fluid communication therethrough (in a bidirectional manner, both “forward” and “backward”) between the NC valve first and second passages 108 and 110. The dual directional flow fluid path permits fluid communication therethrough when the armature 112 is in the second armature position and the poppet 122 is in the second poppet position, as depicted in FIG. 2.

Additionally, the dual directional flow fluid path restricts fluid communication therethrough when the armature 112 is in the first armature position and the poppet 122 is in the first poppet position, as depicted in FIG. 1, with the poppet tip 124 seated against the valve seat 118 in a sealing manner. Due at least in part to action of the poppet spring 130, the NC valve 100 is of the “normally closed” type because the poppet 122 defaults to the first poppet position when the valve is not energized or actuated. In contrast, when electrical power is provided to a coil of the valve 100 to magnetically attract the armature 116 upward toward the core 114 and thus overcome the spring force of the poppet spring 130 to pull the poppet tip 124 away from the valve seat 118, the NC valve 100 can be held open for as long as desired in a particular use environment—or, as long as electrical power thereto is maintained.

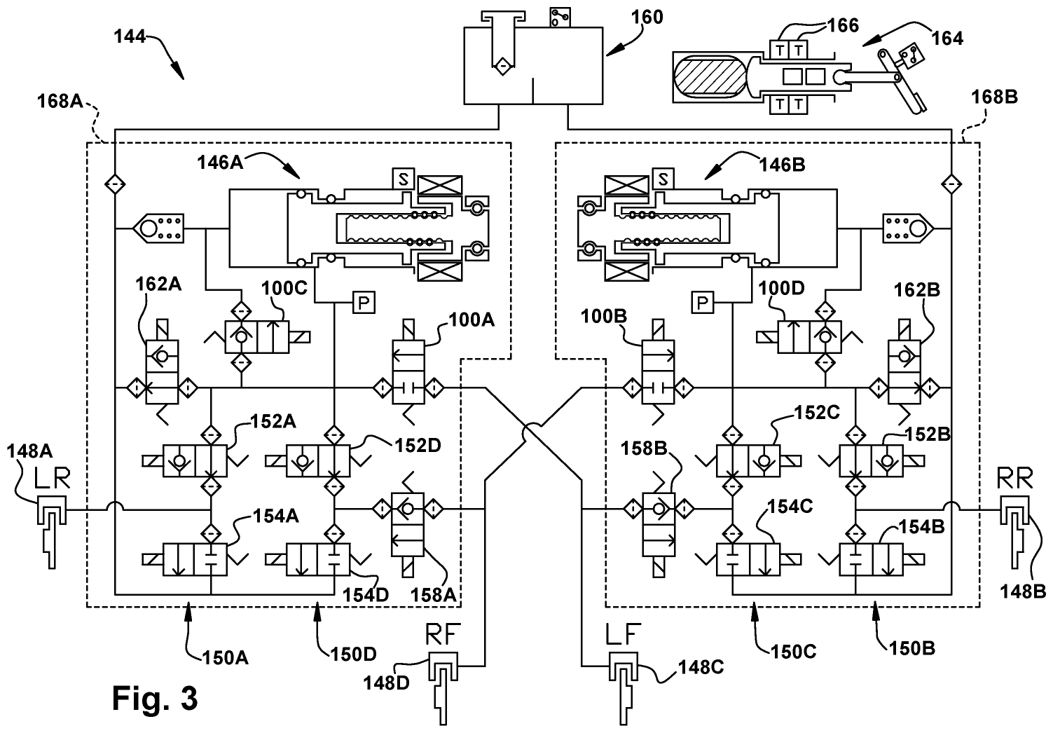

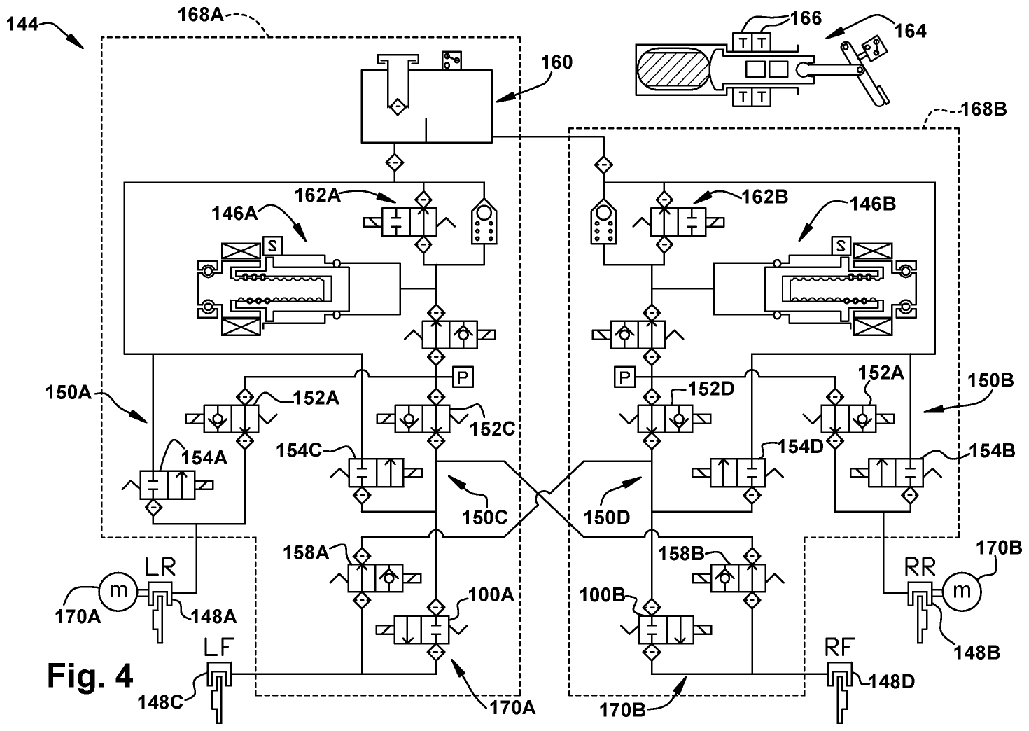

FIGS. 3-4 are schematic depictions of a brake system 144 which includes at least one NC valve 100. The brake system 144, or components thereof, may be or resemble, as one nonlimiting example, one or more of the brake systems shown and described in copending U.S. patent application Ser. No. 17/188,288, titled “Apparatus and Method for Control of a Hydraulic Brake System”, filed 1 Mar. 2021 and incorporated herein by reference in its entirety, for all purposes. The brake system 144, or components thereof, may also be or resemble, as another nonlimiting example, one or more of the brake systems shown and described in copending U.S. patent application Ser. No. 17/708,153, titled “Fault Tolerant Brake System” (attorney docket no. 211653-US-NP), filed concurrently herewith and incorporated herein by reference in its entirety, for all purposes. Description of similar components and operation which is made elsewhere in this application will not necessarily be repeated for each and every described configuration or aspect of the brake system 144, for brevity, but should instead be considered to apply to like-numbered portions of other configurations as appropriate.

The brake systems 144 of FIGS. 3-4 have normal non-failure and backup braking modes. The brake systems 144 each include first and second sources of pressurized hydraulic fluid 146A and 146B. These sources of pressurized fluid 146 are dual-acting plunger units in FIG. 3 and single-acting plunger units in FIG. 4. Each brake system 144 as depicted includes a plurality of wheel brakes 148 (four shown as 148A-148D), comprising a pair of front wheel brakes and a pair of rear wheel brakes.

An iso/dump control valve arrangement 150 is associated with at least one wheel brake of the plurality of wheel brakes 148. As depicted here, each wheel brake 148A-148D includes a corresponding iso/dump control valve arrangement 150A-150D. Each iso/dump control valve arrangement 150 includes an iso valve 152 and a dump valve 154, with letters appended to correlate with individual ones of the brakes. Each iso/dump control valve arrangement 150 is fluidically connected to a selected one of the first and second sources of pressurized hydraulic fluid 146A and 146B.

The brake systems 144 of FIGS. 3-4 also each include first and second shutoff valves 158A and 158B, respectively. Each shutoff valve 158 is interposed hydraulically between a respective front wheel brake 148C, 148D and an iso/dump control valve arrangement 150 corresponding to that front wheel brake. Moreover, the brake systems 144 of FIGS. 3-4 also include first and second balance valves 100A and 100B, respectively, each of which is a dual directional NC valve as described above with reference to FIGS. 1-2.

In the brake systems 144 of FIGS. 3-4, a reservoir 160 is hydraulically connected to the first and second sources of pressurized fluid 146A and 146B.

As shown in FIG. 3, the first and second sources of pressurized hydraulic fluid 146A and 146B are dual-acting plunger units, and each side of the brake system 144 of FIG. 3 includes a venting valve 162A, 162B for directing hydraulic fluid in a predetermined relationship between the reservoir 160 and the corresponding dual-acting plunger type source of pressurized hydraulic fluid 146A or 146B. Each side of the brake system 144 of FIG. 3 also includes one of first and second NC DAP valves 100C and 100D. Each of the first and second NC DAP valves 100C and 100D is interposed hydraulically between the respective first and second sources of pressurized fluid 146A and 146B and at least one corresponding iso/dump control valve arrangement 150.

In contrast, and with reference to the brake system 144 of FIG. 4, the sources of pressurized hydraulic fluid 146A and 146B as depicted are single-acting plunger units, and each “side” of the brake system 144 includes a venting valve 162A, 162B for directing hydraulic fluid in a predetermined relationship between the reservoir 160 and the corresponding single-acting plunger unit type source of pressurized hydraulic fluid 146A or 146B.

With reference more generally to the brake systems 144 shown in both of FIGS. 3-4, an electronic control unit 168 is operative to control the source of pressurized hydraulic fluid 146 and at least one iso/dump control valve arrangement 150, responsive to the braking command signal generated by the deceleration signal transmitter 156 or any other desired provider of a braking command signal.

A brake pedal assembly or other deceleration signal transmitter 164 (manual, autonomous, or automatic) may be provided to generate a braking command signal in any desired manner. For example, when the deceleration signal transmitter 164 includes a traditional brake pedal, a brake travel sensor 166 (here, four shown, for redundancy) may be operative to detect travel of the brake pedal responsive to an operator's foot pressure and thereby provide a braking command signal indicative of a desired braking action.

Brake systems 144 shown in FIGS. 3-4 each include first and second electronic control units, depicted schematically as dashed lines 168A and 168B to indicate the components of each brake system 144 associated with each electronic control unit 168 for power and control. Each of the first and second electronic control units 168A and 168B, as shown, is operative to control a respective first or second source of pressurized fluid 146A, 146B, as well as each of the of the iso/dump control valve arrangements 150 which are associated with at least one of the pair of front wheel brakes and with at least one of the pair of rear wheel brakes. Each electronic control unit 168 can receive a braking command signal from the deceleration signal transmitter 164 or any other desired provider of a braking command. To that end, a plurality of brake travel sensors 166 could be provided to the deceleration signal transmitter 164, for redundant production of brake travel signals in the event of failure of another component of the brake system 144.

In the brake system 144 of FIG. 3, each balance valve 100A, 100B is interposed hydraulically between a corresponding first or second source of pressurized fluid 146A or 146B and a selected one of the pair of front wheel brakes 148C, 148D which is on a same lateral side of the vehicle including the brake system 144 as is a selected one of the pair of rear wheel brakes 148A, 148B which is supplied by the same first or second source of pressurized fluid 146A or 146B. In other words, and as shown in FIG. 3, when the brake system 144 is in a normal, non-failure braking mode, the first source of pressurized fluid 146A provides fluid to the left rear wheel brake 148A and the right front wheel brake 148D, via shutoff valve 158A. Similarly, and as shown in FIG. 3, when the brake system 144 is in a normal, non-failure braking mode, the second source of pressurized fluid 146B provides fluid to the right rear wheel brake 148B and the left front wheel brake 148C, via shutoff valve 158B.

When the brake system 144 depicted in FIG. 3 is in the backup braking mode, a selected first or second shutoff valve 158A or 158B enters a closed condition to prevent a corresponding one of the first and second sources of pressurized fluid 146A and 146B from supplying hydraulic fluid to the reservoir 160. A selected one of the first and second balance valves 100A or 100B accordingly places the failed-side one of the pair of front wheel brakes 148C or 148D into fluid communication with a remaining one of the first and second sources of pressurized fluid number 146A and 146B which is also supplying pressurized hydraulic fluid to the contralateral one of the pair of front wheel brakes 148C or 148D in both the backup braking and normal non-failure braking modes.

Stated differently, in the brake system 144 of FIG. 3, the first source of pressurized fluid 146A supplies hydraulic fluid to left rear wheel brake 148A and right front wheel brake 148D in a normal, non-failure braking mode, and additionally to those (when in a backup braking mode), supplies fluid to left front wheel brake 148C when the second ECU 168B, the second source of pressurized fluid 146B, or any other component of the brake system inside dashed box 168B of FIG. 3 is not available for operation. Likewise, in the brake system 144 of FIG. 4, the second source of pressurized fluid 146B supplies hydraulic fluid to right rear wheel brake 148B and left front wheel brake 148C in a normal, non-failure braking mode, and additionally to those (when in a backup braking mode), supplies fluid to right front wheel brake 148D when the first ECU 168A, the first source of pressurized fluid 146A, or any other component of the brake system inside dashed box 168A of FIG. 3 is not available for operation

Turning now to FIG. 4, all four of the wheel brakes 148 are shown as being hydraulically operated, with the two rear wheel brakes 148A, 148C additionally being provided with an electric backup motor 170 (shown here as 170A, 170B) for selectively actuating the selected wheel brake 148 in a backup braking mode. While the rear wheel brakes 148A, 148C are used as an example here, at least one selected wheel brake 148 could have an electric backup motor 170 provided within the brake system 144 of FIG. 4 in any position, as desired. In most use environments, the electric backup motors 170 will be less robust or powerful than a “primary” electric service brake motor in that position would be, since the electric backup motors 170 are supplemental to the hydraulic operation of each “backed up” wheel brake 148. To that end, however, and when first and second electronic control units 168A and 168B are both provided to the brake system 144 (as in the FIG. 4 arrangement), the electric backup motor 170 for each selected wheel brake 148 may be controlled by a chosen one of the first and second electronic control units 168A and 168B which does not control the iso/dump control valve arrangement 150 respective to the selected wheel brake 148. As a result, the “backed up” wheel brakes 148 exhibit redundancy in control and actuation types, which may be helpful in maintaining some function in the brake system 144 when one of the electronic control units 168A and 168B is not available.

The brake system 144 of FIG. 4 includes first and second electronic control units 168A and 168B, each of which is operative to control a respective first or second source of pressurized fluid 146A and 146B and each iso/dump control valve arrangement 150 which is associated with a selected one of the pair of front wheel brakes 148C, 148D and a selected one of the pair of rear wheel brakes 148A, 148B which are on opposite lateral sides of a vehicle which includes the brake system 144. That is, as shown in FIG. 4, the first electronic control unit 168A controls the first source of pressurized fluid 146A and the iso/dump control valve arrangements 150 which are associated with the left rear and right front brakes 148A, 148D. The second electronic control unit 168B controls the second source of pressurized fluid 146B and the iso/dump control valve arrangements 150 which are associated with the right rear and left front brakes 148B, 148C.

When the brake system 144 of FIG. 4 is in the normal non-failure mode, each of the first and second sources of hydraulic fluid 146A and 146B supplies pressurized hydraulic fluid to the selected one of the pair of front wheel brakes 148C, 148D and the selected one of the pair of rear wheel brakes 148A, 148B which are on opposite lateral sides of the vehicle (e.g., left front/right rear and left rear/right front).

Conversely, when the brake system 144 of FIG. 4 is in the backup braking mode, a selected first or second balance valve 100A or 100B enters an open condition to allow a corresponding one of the first and second sources of pressurized fluid 146A and 146B to supply hydraulic fluid to a corresponding failed-ECU-side one of the pair of front wheel brakes 148C and 148D. That selected one of the first and second balance valves 100A and 100B accordingly places the failed-side one of the pair of front wheel brakes 148C and 148D into fluid communication with a remaining one of the first and second sources of pressurized fluid 146A and 146D which is also supplying pressurized hydraulic fluid to the contralateral one of the pair of front wheel brakes 148C and 148D in both the backup braking and normal non-failure braking modes.

Stated differently, in the brake system 144 of FIG. 4, the first source of pressurized fluid 146A supplies hydraulic fluid to left rear wheel brake 148A and right front wheel brake 148D in a normal, non-failure braking mode, and additionally to those (when in a backup braking mode), supplies fluid to left front wheel brake 148C when the second ECU 168B, the second source of pressurized fluid 146B, or any other component of the brake system inside dashed box 168B of FIG. 3 is not available for operation. Likewise, in the brake system 144 of FIG. 4, the second source of pressurized fluid 146B supplies hydraulic fluid to right rear wheel brake 148B and left front wheel brake 140C in a normal, non-failure braking mode, and additionally to those (when in a backup braking mode), supplies fluid to right front wheel brake 148D when the first ECU 168A, the first source of pressurized fluid 146A, or any other component of the brake system inside dashed box 168A of FIG. 3 is not available for operation

Finally, in some use environments, at least one of the first and second balance valves 100A and 100B comprises at least a portion of a backup valve pair 170A, 170B cooperatively with a respective first or second shutoff valve 158A or 158B. Each backup valve pair 170A, 170B, when present, may be associated with a selected one of the front wheel brakes 148C, 148D corresponding to the respective first or second balance valves 100A or 100B. Each of the first and second shutoff valves 158A and 158B selectively permits the associated front wheel brake 148C, 148D to vent to reservoir 160 when the shutoff valve 158A or 158B is in a nonpowered condition

It is contemplated that, when at least one component of the brake system 144 has failed, a selected one of the first and second shutoff valves 158A or 158B may be energized in conjunction with energization of the same-side (i.e., first or second) balance valve 100 of the corresponding backup valve pair 170A, 170B. As a result, the crossover-type switching described above and shown in the Figures can be accomplished to maintain braking operation in backup mode of both of the pair of front brakes 148C, 148D despite a failure of one or more components normally associated with one of the front brakes.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A dual-directional normally closed valve (“NC valve”), comprising:
a housing having a center bore extending longitudinally from a first housing surface, the housing including an NC valve first passage in fluid communication with the center bore, the housing including an NC valve second passage extending therethrough in fluid communication with the center bore, the NC valve first passage being located longitudinally between the first housing surface and the NC valve second passage;
an armature for selective longitudinally reciprocating motion with respect to the center bore between first and second armature positions;
a valve seat located within the center bore in selective fluid communication with the NC valve first and second passages; and
a poppet located at least partially within the housing and interposed longitudinally between the armature and the valve seat, the poppet being at least partially maintained in engagement with the armature and carried thereby for selective longitudinally reciprocating motion with respect to the valve seat between first and second poppet positions, the poppet defining a dual-directional valving structure cooperatively with the valve seat;
wherein the NC valve first passage, poppet, valve seat, and NC valve second passage cooperatively define a dual directional flow fluid path therebetween, the dual directional flow fluid path selectively permitting fluid communication therethrough between the NC valve first and second passages, the dual directional flow fluid path permitting fluid communication therethrough when the armature is in the second armature position and the poppet is in the second poppet position; and
wherein the dual directional flow fluid path restricts fluid communication therethrough when the armature is in the first armature position and the poppet is in the first poppet position.

2. The dual-directional normally closed valve of claim 1, including a core for selectively magnetically attracting the armature, the core being located longitudinally directly adjacent a core-activated surface of the armature, the armature being longitudinally interposed between the core and the poppet, the core being selectively energized to magnetically drive the armature between the first and second armature positions;

3. The dual-directional normally closed valve of claim 2, wherein an armature-attracting face of the core and the core-activated surface of the armature are substantially planar.

4. The dual-directional normally closed valve of claim 1, including an annular valve body located in the center bore substantially laterally surrounding at least a portion of the poppet, the valve body including at least one body side aperture laterally therethrough, the body side aperture being longitudinally aligned with at least a portion of the NC valve first passage and permitting fluid flow therethrough from the NC valve first passage to the valve seat.

5. The dual-directional normally closed valve of claim 1, including a poppet spring biasing the poppet into sealing engagement with the valve seat in the first poppet position.

6. The dual-directional normally closed valve of claim 4, including a poppet spring extending longitudinally between, and exerting compressive force upon, a poppet shoulder of the poppet and a body shoulder of the valve body, the poppet spring biasing the poppet into sealing engagement with the valve seat in the first poppet position.

7. The dual-directional normally closed valve of claim 2, wherein a core sleeve is received at least partially in the center bore of the housing to maintain the core in spaced relationship therewith, the armature being at least partially enclosed within the core sleeve and guided thereby for selective longitudinal reciprocating motion with respect to the core.

8. The dual-directional normally closed valve of claim 5, wherein the core sleeve entirely longitudinally encloses the armature therein, with the core located at a first end of the core sleeve.

9. The dual-directional normally closed valve of claim 8, wherein the core sleeve is maintained in the center bore of the housing via a staked connection.

10. The dual-directional normally closed valve of claim 1, wherein at least one of the NC valve first and second passages includes a filter directly adjacent thereto within the center bore for filtering fluid flow therethrough.

11. The dual-directional normally closed valve of claim 1, including a seat ring located within the center bore adjacent the NC valve second passage, the seat ring defining the seat.

12. The dual-directional normally closed valve of claim 1, wherein the NC valve second passage is located at a portion of the center bore longitudinally furthest from the first housing surface.

13. The dual-directional normally closed valve of claim 1, wherein the dual-directional valving structure is configured to resist a larger amount of incoming fluid pressure from the NC valve first passage than an amount of incoming fluid pressure from the NC valve second passage.

14. The dual-directional normally closed valve of claim 1, wherein the armature includes a poppet-receiving aperture extending into an armature surface longitudinally opposite the core-activated surface, the poppet-receiving aperture maintaining at least a stem portion of the poppet therein.

15. A brake system having normal non-failure and backup braking modes, the brake system comprising:
first and second sources of pressurized hydraulic fluid;
a plurality of wheel brakes, comprising a pair of front wheel brakes and a pair of rear wheel brakes;
an iso/dump control valve arrangement associated with at least one wheel brake of the plurality of wheel brakes, each iso/dump control valve arrangement including an iso valve and a dump valve, and each iso/dump control valve arrangement being fluidically connected to a selected one of the first and second sources of pressurized hydraulic fluid;
first and second shutoff valves, each shutoff valve interposed hydraulically between a respective front wheel brake and a corresponding iso/dump control valve arrangement;
first and second balance valves, with each balance valve being a dual directional normally closed valve according to claim 1, each balance valve being interposed hydraulically between a corresponding first or second source of pressurized fluid and a selected one of the pair of front wheel brakes which is on a same lateral side as a selected one of the pair of rear wheel brakes which is supplied by the same first or second source of pressurized fluid;
a reservoir hydraulically connected to the first and second sources of pressurized fluid; and
first and second electronic control units, each of the first and second electronic control units operative to control a respective first or second source of pressurized fluid and each iso/dump control valve arrangement which is associated with at least one of the pair of front wheel brakes and at least one of the pair of rear wheel brakes;
wherein, when the brake system is in the normal non-failure mode, each of the first and second sources of hydraulic fluid supplies pressurized hydraulic fluid to the selected one of the pair of front wheel brakes and the selected one of the pair of rear wheel brakes which are on opposite lateral sides of the vehicle; and
when the brake system is in the backup braking mode, a selected first or second shutoff valve enters a closed condition to prevent a corresponding one of the first and second sources of pressurized fluid from supplying hydraulic fluid to a corresponding failed-side reservoir, and a selected one of the first and second balance valves accordingly places the failed-side one of the pair of front wheel brakes into fluid communication with a remaining one of the first and second sources of pressurized fluid which is also supplying pressurized hydraulic fluid to the contralateral one of the pair of front wheel brakes in both the backup braking and normal non-failure braking modes.

16. The brake system of claim 15, wherein the source of pressurized hydraulic fluid is a dual-acting plunger unit, and the brake system includes a venting valve for directing hydraulic fluid in a predetermined relationship between the reservoir and the dual-acting plunger unit.

17. The brake system of claim 15, including first and second NC DAP valves, each of the first and second NC DAP valves being interposed hydraulically between the respective first and second sources of pressurized fluid and at least one corresponding iso/dump control valve arrangement.

18. A brake system having normal non-failure and backup braking modes, the brake system comprising:
first and second sources of pressurized hydraulic fluid;
a plurality of wheel brakes, comprising a pair of front wheel brakes and a pair of rear wheel brakes;
an iso/dump control valve arrangement associated with at least one wheel brake of the plurality of wheel brakes, each iso/dump control valve arrangement including an iso valve and a dump valve, and each iso/dump control valve arrangement being fluidically connected to a selected one of the first and second sources of pressurized hydraulic fluid;
first and second balance valves, each of the balance valves being a dual directional normally closed valve according to claim 1, each balance valve being interposed hydraulically between a corresponding first or second source of pressurized fluid and a selected one of the pair of front wheel brakes which is on an opposite lateral side from a selected one of the pair of rear wheel brakes which is supplied by the same first or second source of pressurized fluid;
a reservoir hydraulically connected to the first and second sources of pressurized fluid; and
first and second electronic control units, each of the first and second electronic control units operative to control a respective first or second source of pressurized fluid and each iso/dump control valve arrangement which is associated with the selected one of the pair of front wheel brakes and the selected one of the pair of rear wheel brakes which are on opposite lateral sides of a vehicle;
wherein, when the brake system is in the normal non-failure mode, each of the first and second sources of hydraulic fluid supplies pressurized hydraulic fluid to the selected one of the pair of front wheel brakes and the selected one of the pair of rear wheel brakes which are on opposite lateral sides of the vehicle; and
when the brake system is in the backup braking mode, a selected first or second balance valve enters an open condition to allow a corresponding one of the first and second sources of pressurized fluid to supply hydraulic fluid to a corresponding failed-side one of the pair of front wheel brakes, and the selected balance valve accordingly places the failed-side one of the pair of front wheel brakes into fluid communication with a remaining one of the first and second sources of pressurized fluid which is also supplying pressurized hydraulic fluid to the contralateral one of the pair of front wheel brakes in both the backup braking and normal non-failure braking modes.

19. The brake system of claim 18, wherein the source of pressurized hydraulic fluid is a single-acting plunger unit, and the brake system includes a venting valve for directing hydraulic fluid in a predetermined relationship between the reservoir and the single-acting plunger unit.

20. The brake system of claim 18, wherein at least one selected wheel brake of the plurality of wheel brakes includes an electric backup motor for selectively actuating the selected wheel brake in a backup braking mode, the electric backup motor being controlled by a chosen one of the first and second electronic control units which does not control the iso/dump control valve arrangement respective to the selected wheel brake.

21. The brake system of claim 18, wherein each of the first and second balance valves comprises a backup valve pair cooperatively with a corresponding first or second shutoff valve, each backup valve pair being associated with a selected one of the front wheel brakes corresponding to the respective first or second balance valves, each shutoff valve selectively permitting the associated front wheel brake to vent to reservoir when the shutoff valve is in a nonpowered condition.
